(19) United States
(12) Patent Application Publication
(10) Pub. No.: US 2011/0047859 A1
(43) Pub. Date: Mar. 3, 2011

(54) ANIMAL TRAP

(76) Inventor: Jose A. MENDEZ, Ellsworth, KS (US)

(21) Appl. No.: 12/549,217

(22) Filed: Aug. 27, 2009

(51) Int. Cl. A01M 23/24

(52) U.S. Cl. 43/81; 43/96

(57) ABSTRACT

An improvement on an animal trap that humanely and bloodlessly kills the object animal. The trap is particularly adapted to rodent rat snap-traps with upright life terminating engagement surfaces (LTES) that create a killing surface when the wire bail of the trap strikes the object animal.

### FIELD OF THE INVENTION

This invention relates generally to the artful killing of animals and more particularly to terminating rodents, including rats, utilizing novel improvements to conventional snap-traps and the like.

### BACKGROUND OF THE INVENTION

Rodents are pervasive pests when it comes to agricultural products. It is estimated there are over one billion rats on poultry and agriculture farms that cause approximately 15 billion U.S. dollars worth of economic damage. In urban and suburban areas there is estimated to be one rat per human. These animals cause fires by gnawing on wires, they pollute foodstuffs, and they carry disease such as salmonellosis and leplospirosis.

Rats come in all different shapes and sizes. The most common rats are the Norwegian rat (rattus norwegicus) or the common roof rat (Rattus rattus). They range in size from 10 oz to 16 oz. The normal ways of exterminating or removing common rats are snap traps, live animal traps, electronic sonic disturbance, poison baits, and glue pads. Snap traps tend to have low success level for killing rats. Because of rats' large size, many times the rats will run off with the trap attached to them. Other cases, the rat may be trapped under the wire jaws of the snap trap and squirm and fight for survival for many hours and finally succeed in prying themselves loose. One problem with the fight for survival is that after fighting with the trap for several hours it will frequently leave blood or other body fluids on the trap from their appendages and orifices. Once blood gets on the traps, they will need to be cleaned since the other rats will smell the residual fluids and avoid the trap altogether. Live animal traps are humane traps but the animal is not exterminated and must be disposed of in another area or killed by some other means. The electronic sonic repellants merely ward off the animals to areas outside the offending sonic disturbance. Poison baits are efficient in their killing of the rodents but the poisoned animals may wander off to die and cause odors from their decay. Further, the deceased poisoned rodents and the poison baits can be ingested by other domesticated animals, and such poison baits can present a danger to children. Glue traps are effective but many question their humane killing of the rodent because the animals usually die from dehydration after long struggles. Methods of trapping and exterminating that are efficient and humane have generally not been widely available.

Conventional snap traps generally comprise a wire bail that is cocked on a spring and held in place by another wire or by some latching system on a base made of wood or other suitable rigid material. The bait area has either a triggering plate or a platform that the animal triggers when it steps on it to retrieve the bait, or the bait is on a catch mechanism that slides the wire bail holder, triggering the forceful movement of the wire bail. Once triggered the wire bail forcefully strikes the animal in the bait zone, sometimes killing it, and often merely wounding it. The lack of a killing strike allows the animal to pry itself out of the trap and escape or to inhumanely squirm and fight until it dies from exhaustion or dehydration. Improvements upon the snap trap usually come in the form of the triggering mechanism such as a trigger platform as seen in U.S. Pat. Nos. 1,464,559 and 5,375,367. Other improvements relate to the cocking mechanism to make it safer for the user to bring the bail back to a set position as seen in U.S. Pat. Nos. 4,574,519 and 4,711,049. Another patent similar to snap traps is a jaw clip type trap seen in U.S. Pat. No. 6,508,031, resembling a hair clip, in which the user sets the jaws apart with the bait inside and the animal triggers the jaws when interacting with the bait.

### SUMMARY OF THE INVENTION

One or more of the embodiments of the invention provide improvements upon the general type of snap traps in order to kill the trapped animal and leave a bloodless kill zone. These embodiments can be used on any suitable animal, rodents, and more specifically rats, and are a primary focus of the embodiments described herein.

In an embodiment of the invention the kill zone, also called the animal staging area, is surrounded on three sides by generally rigid upright flanges. These upright flanges are usually rectangular and relatively thin. The flanges are set on the staging area in such a way that the animal's head must protrude over the flange in order to get to the bait. After triggering, the spring loaded wire bail will strike the animal about the dorsal area of the neck and shoulders driving the animal's ventral neck onto the flange causing the animal to expire almost immediately. Without further exploring the death, expiration is likely caused by either breaking of the spinal column thus severing nerves or breaking of the tracheal area causing blockage and suffocation of the animal. The quick death of the animal foregoes the struggling and maiming of the animal which often happens in current snap traps and, at the same time, results a bloodless kill zone.

The upright flanges may be fully integrated into the snap trap itself when it is manufactured, or they could be a retro-fit structure for commercially available traps.

Another embodiment of the invention is a snap trap kit that includes, optionally, a snap trap, a removable life terminating engagement area, appropriate attachment means, optionally some animal bait, and optionally an animal disposal bag.

### BRIEF DESCRIPTION OF THE DRAWING

The objects, advantages, and features of the invention will become more apparent from the following detailed description, when read in conjunction with the accompanying drawing, in which:

FIG. 1 is a perspective view of a rodent trap in the set position to which one embodiment of the invention is attached;

FIG. 2 is a perspective view of the FIG. 1 embodiment from a different direction, with the wire bail in the strike position;

FIG. 3 is a side view of the FIG. 2 embodiment;

FIG. 4 is a top view of the FIG. 2 embodiment;

FIG. 5 is a perspective view of a sleeve-type retrofit embodiment of the invention for attachment to a rodent trap;

FIG. 6 is a perspective view of the invention integrally formed with the base of a rodent trap;

FIG. 7 is a top view similar to FIG. 4, with the wire bail inside the upright flanges in the strike position; and

FIG. 8 is a top view of a trap in accordance with this invention with a rat successfully terminated therein.

### DETAILED DESCRIPTION OF THE PREFERRED EMBODIMENTS

In the following exemplary description numerous specific details are set forth in order to provide a more thorough understanding of embodiments of the invention. It will be apparent, however, to an artisan of ordinary skill that the present invention may be practiced without incorporating all aspects of the specific details described herein. In other instances, specific features, or measurements well known to those of ordinary skill in the art have not been described in detail so as not to obscure the invention. Although examples of the invention are set forth herein, the claims and the full scope of any equivalents are what define the metes and bounds of the invention.

In describing the invention and embodiments, the following terms will be employed and are intended to be defined as indicated below. If any terms are not fully defined, then the normal usage as used in the art will fill any gaps in the understanding of the terminology.

As used in this specification and in the appended claims, the singular forms “a,” “an” and “the” include plural references unless the content clearly dictates otherwise.

The use of the word “preferably” in its various forms is explanatory for ease of reading, and should not be used to read into the claims as limiting or anything more.

“Humane” as used herein is the ethical killing of animals in a swift manner, usually instantaneously or in a very short time, preferably less than a minute.

“Bloodless” is considered where the struck animal or expired animal does not secrete blood from parts, appendages, or orifices thus leaving the trap sufficiently free of blood or other body fluids.

“Life terminating engagement surface” (LTES) is any raised surface from the trap's base that the targeted animal body engages to effect a killing

“Set Position” is when the wire bail is pulled against the coiled springs into a cocked position where the wire bail is resting on or near the base of trap on the opposite side of the base from the bait. It is held there by either a holding wire set onto a friction fit of a baitable catch or by some other means.

“Strike position” is when the wire bail is released from the set position and is forced down onto the animal staging area or kill zone.

The “kill zone” area of the trap, also known as the staging area, is the location in which the animal is engaged by the wire bail and the life terminating engagement surface causes a death blow.

“Trigger platform” is an area of the trap located in the animal staging area that the target animal engages and triggers the wire bail to move to the strike position.

“Fixable” as used in the disclosure and the claims is having the ability to make fast, firm, or stable. Or to be able to be placed definitely and more or less permanently. Though something is said to be fixable it could be removed, exchanged, or modified. For example, if the LTES was molded onto the trap then it would not be considered fixable and not removable. Furthering the example, if the LTES was attached by means of screws then it would be considered fixable and could possibly be removed.

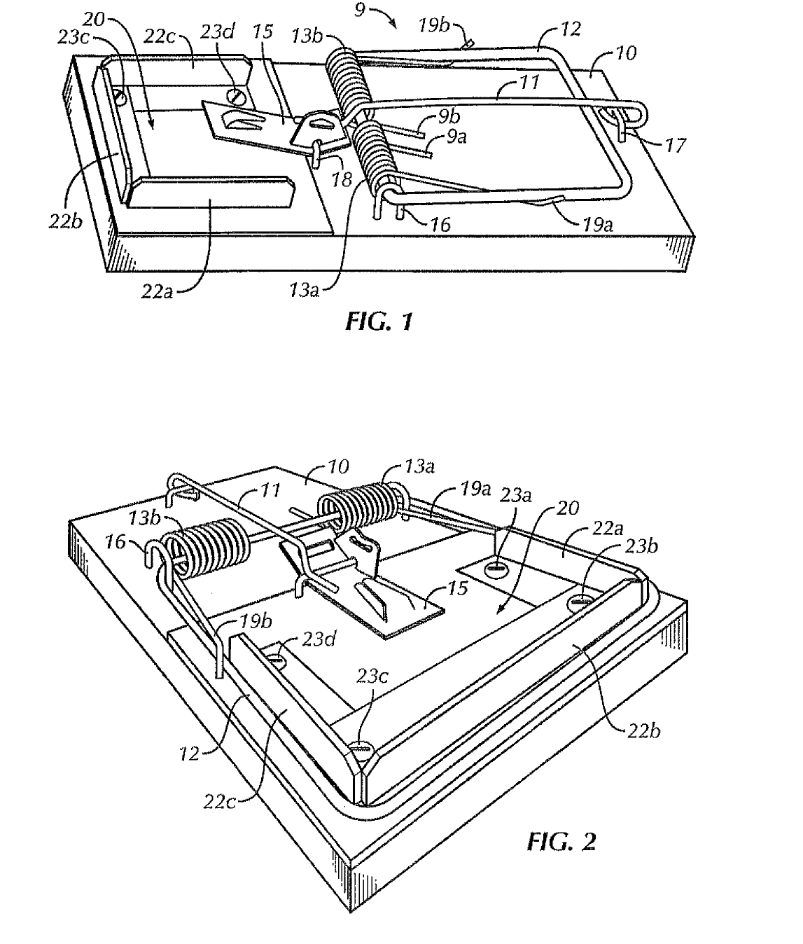

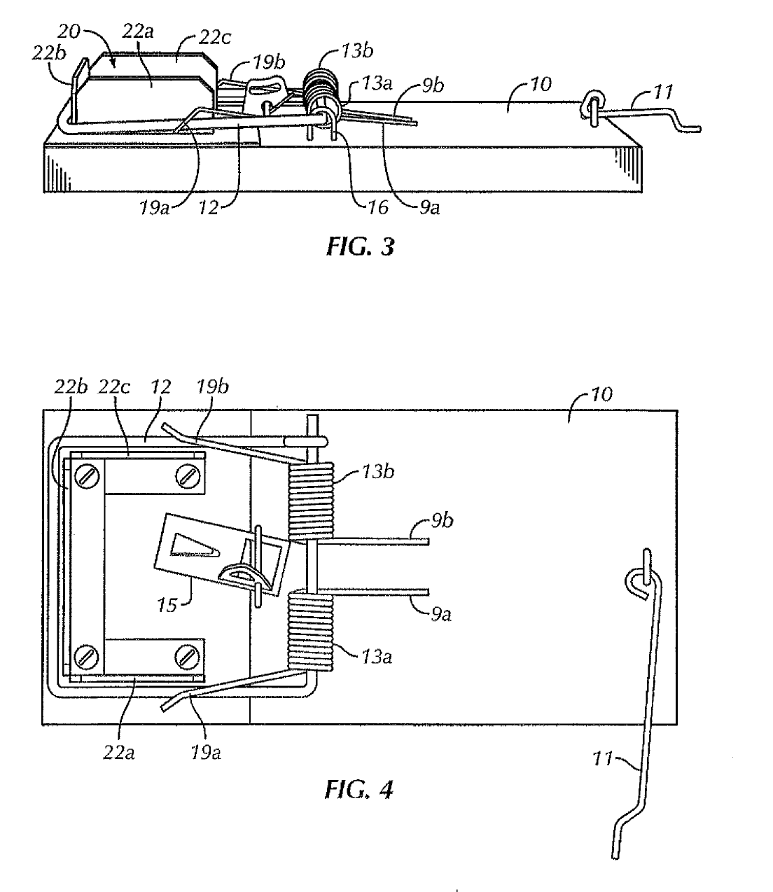

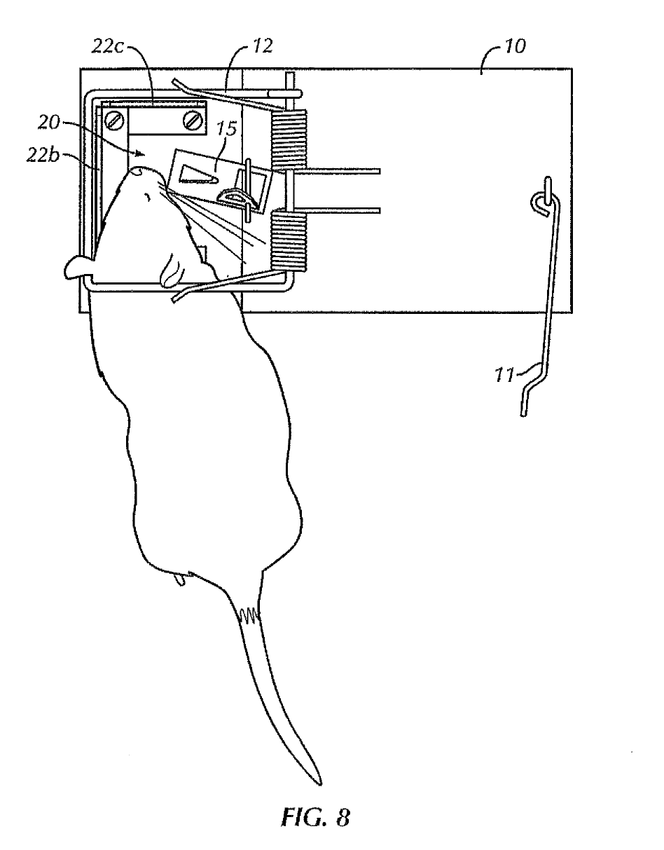

Referring to the embodiment of FIG. 1, conventional commercially available snap trap 9 has a rectangular base 10 made of material such as wood, metal, veneer, pressboard, plywood, plastic, or a composite, among others. Rectangular wire bail 12 may be attached on base 10 by means of staples 16. The wire bail is of conventional commercially available material such as heavy steel. Dual coil springs 13a and 13b are wrapped around the attached end of the wire bail. Springs 13a and 13b are coiled with their pressure ends 9a, 9b, and 19a, 19b pressed against base 10 toward the middle of the wire bail and on both elongated sides of wire bail 12, respectively. Holding wire 11 may be attached to base 10 with staple 17. Holding wire 11 will hold wire bail 12 in the set position when the wire bail is pivoted against the pressure of the coiled springs with the end of the holding wire 11 set onto a pressure or tension fit with baitable catch 15, which is also known as a baiting mechanism in this and other embodiments. FIG. 1 shows holding wire 11 in the set position, engaging baitable catch 15 and holding wire bail 12 in a high tension position. Catch 15 may be attached to the base 10 by any effective means, such as staple 18. Animal staging area 20 is the area also known as the “kill zone” which encompasses the end of base 10 in which wire bail 12 touches the base 10 when it is fully sprung, a position also known as the strike position. The fully sprung wire bail in the strike position is shown in FIG. 2 (and again in FIG. 8). The above is a general description of a conventional mouse or rat trap.

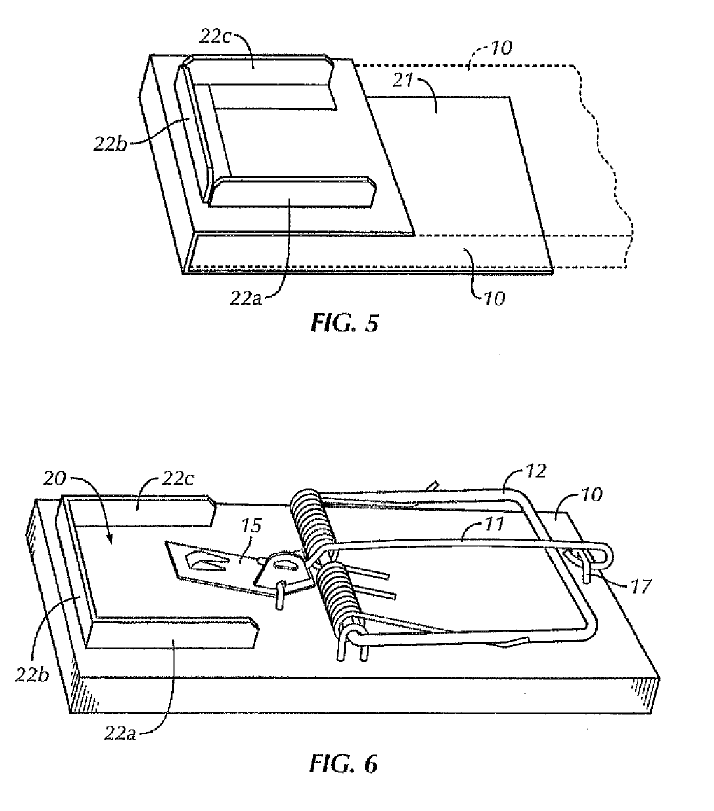

At the end of base 10, in the vicinity of the kill zone, are life terminating engagement surfaces (LTES) comprised of upright flanges 22a, 22b, and 22c. It is contemplated that the upright flanges can be individually attached or molded onto base 10, or molded together to be attached or molded to base 10 as shown in FIG. 6. An alternative embodiment is shown in FIG. 5 and will be discussed below. Preferably upright flanges 22a-22c are arranged at about 90 degrees with respect to each other, generally following the rectangular shape of wire bail 12. Other useful shapes and configurations of the upright flanges are contemplated as long as they effect the killing of the targeted animal. It is contemplated that each individual flange, or the flanges as a group, will have profile shapes that can be rectangular, polygonal, ellipsoidal or any shape that effect a killing blow. The shape of the flanges as a group are contemplated to include the U-shape shown, or various polygonal or rounded shapes that integrate into kill zone 20 such that bail 12 strikes the animal forcing it down upon an upright flange 22a-22c in a killing manner. The bail itself may have a shape other than rectangular, to which the flanges can be matched.

The upright flanges are contemplated to stand at an angle between 65 degrees and 115 degrees, preferably between 85 and 95 degrees and most preferably at 90 degrees with respect to base 10. Any angle that effects a killing upon the animal is contemplated.

The height of upright flanges 22a-22c is contemplated to be between about 0.25 inch and about 0.75 inch, preferably about 0.50 inch. The length of the upright flanges is approximately 2 inches, though any length that coordinates with the wire bail to effect a killing is contemplated. The distance between fully sprung wire bail 12 and the upright flanges is preferably less than 0.25 inch, more preferably within about 0.125 inch.

The life terminating engagement surface should be only as sharp as to not allow cutting into the target animal's flesh. The thickness of the engagement surface should be between 0.0313 inch and 0.125 inch, preferably about 0.0625 inch. Attaching the upright flanges to base 10 may be effected by screws 23a-23d as seen in FIGS. 1, 2, 4, and 7, or by nuts and bolts, polymer adhesives and glues, hook and clasp fasteners, pressure fit, groove guides, snap locks, or other effective chemical or mechanical attachment means and the like.

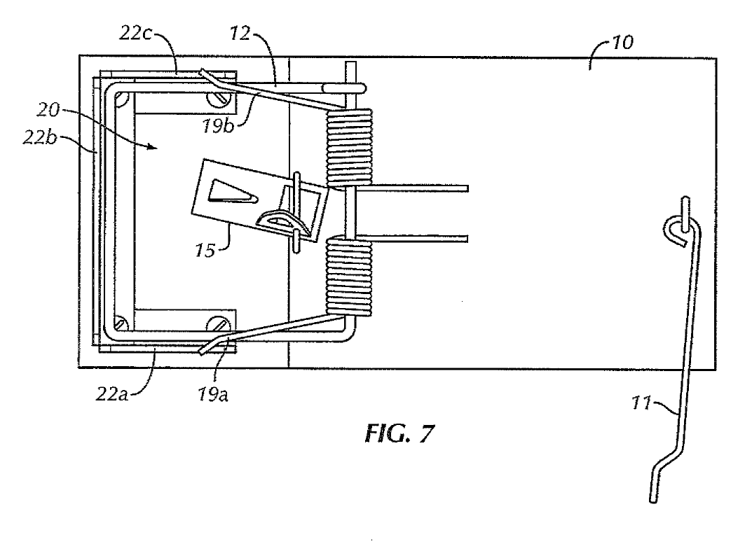

The method of killing shown by this embodiment comprises the steps of, first, setting the trap by: a) applying any suitable bait to baitable catch 15, possibly with some animal attractant in addition to the bait; b) cocking wire bail 12 by pivoting it against the tension of springs 13a and 13b; and c) placing holding wire 11 over wire bail 12 and engaging it with the releasable retainer on catch 15. This is conventional for setting a trap of this type. Optionally, if the LTES is not in place before setting the trap, the various embodiments of LTES can be attached to the trap preliminary to setting the trap. The trap is sprung mechanically by disengaging the baitable catch from holding wire 11 through an attracted target animal's interaction with the catch. Death results from suddenly striking the animal's dorsal side in the neck or upper shoulders with wire bail 12, forcing the animal's ventral throat against the life-terminating engagement surface, causing a quick death. In some embodiments the wire bail, when in the strike position in the kill zone, can be positioned or oriented to the exterior of the LTES as seen in FIGS. 1 and 4 or in other embodiments to the interior of the LTES as seen in FIG. 7. In this FIG. 7 alternative embodiment the height of the flanges 22a and 22c are reduced if and as necessary to accommodate the ends of spring pressure ends 19a and 19b.

This method of trapping and killing of rodents is superior to the way conventional snap traps function, as seen in Chart 1, based on experimental evidence.

Chart 1. Rat Kill/Escape ratio comparison (n=10)

| Trap | Killed | Escaped | Percent Killed |
|---|---|---|---|
| Snap trap without LTES | 4 | 6 | 40 |
| Snap trap with LTES | 10 | 0 | 100 |

This chart represents an easy test comparison of a snap trap without the life terminating engagement surfaces of this invention and a snap trap with the subject LTES. Of the ten rats that were exposed to the trap without the LTES, only 4 were killed when the trap was sprung on them, possibly after an extended struggle, and six escaped, possibly significantly injured. Of the ten rats that were exposed to the trap with LTES, all ten were killed relatively quickly without any appreciable blood found on the trap. None escaped.

Embodiments of the invention are contemplated in which the life terminating engagement surfaces are, for example, molded, attached individually, or attached as a molded group onto the trap base in the animal staging area.

In an embodiment of the invention shown in FIG. 5, removable sleeve 21 including LTES is contemplated to be made out of any suitable material such as metal, plastic, wood, or a composite. Any method of manufacture and shape is contemplated that would be useful for the style of trap. On the upper surface of removable sleeve 21, in a square bottomed “U” shape, are the LTES that, in this embodiment, are fixable upright flanges 22a, 22b and 22c. Any attachment means suitable for the purposes of attaching the sleeve onto a trap are contemplated, with examples such as self tapping screws, nuts and bolts, polymer adhesives and glues, hook and clasp fasteners, pressure fit, groove guides, snap locks, or other effective chemical or mechanical attachment means and the like. Removable sleeve 21 can have the LTES molded or fixed on to the upper side by some appropriate attachment means.

Another embodiment encompasses an animal killing trap kit. The kit may optionally comprise on or more of the following: a) a conventional snap trap as shown and described; b) attachable life terminating engagement surfaces, an example being sleeve 21 shown in FIG. 5; c) animal attractant bait; and d) a disposal bag for the deceased animal. The kit optionally comprises b) as a retro-fit device for conventional snap traps, or it could have a) and b) already combined.

While the present embodiments have been illustrated and described by means of specifics and alternatives, it is to be understood that numerous changes and modifications can be made herein without departing from the purpose and scope of the invention. Improvements in these and other embodiments of the present invention will readily occur to those of ordinary skill in the art in view of this disclosure. Therefore it should be understood that the invention is not to be limited in any way except in accordance with the appended claims and their equivalents. The invention is not restricted to the illustrated embodiments, but it may be varied without departing from the scope of the inventive concept. The scope of the protection sought by the inventor will be shown from a fair reading of the claims that are appended hereto.

What is claimed is:

1. An improvement on an animal trap of the type comprising a substantially rigid base on which a spring loaded bail is secured, and a bait mechanism engageable by a holding wire arranged to temporarily hold the bail in a set position, the invention comprising:
means for terminating the life of an animal comprising life terminating engagement surfaces (LTES) on the base which co-act with the bail when the bail moves to the sprung position onto the animal.

2. The animal trap of claim 1, wherein said LTES is an upright flange

3. The animal trap of claim 2, wherein said upright flange is between about a 65 degree and about a 115 degree angle from the base of the trap.

4. The animal trap of claim 3, wherein said upright flange extends upwardly at about 90 degrees from the base of the trap.

5. The animal trap of claim 2, wherein said upright flange is fixable to the base.

6. The animal trap of claim 2, wherein said upright flange is formed on a sleeve which is removably securable to the base.

7. An animal trap comprising:
a base;
a spring operated wire bail mounted on said base and having a set position and a strike position;
a means for temporarily retaining said bail in the set position;
a baitable motion sensitive catch means;
an animal staging area; and
life terminating engagement surfaces (LTES) mounted on said animal staging area.

8. The animal trap of claim 7, wherein said animal staging area is a platform which, when activated by an animal, releases the wire bail to move to the strike position.

9. The animal trap of claim 7, wherein said LTES comprises upright flanges.

10. The animal trap of claim 9, wherein said upright flanges surround said baitable catch on three sides with the open side facing the set position area.

11. The animal trap of claim 9, wherein said upright flange extends upwardly at about 90 degrees from said animal staging area.

12. The animal trap of claim 9, wherein said upright flange is between about 0.25 inch and about 0.75 inch in height from said animal staging area.

13. The animal trap of claim 7, wherein said LTES is formed as a sleeve with fixable upright flanges, said sleeve being mounted to said base by sliding onto said animal staging area of said base.

14. An animal trap kit comprising a snap trap, removable life terminating engagement surfaces (LTES), and means for attaching said LTES to said trap.

15. In combination with an animal trap comprising a substantially rigid base on which a spring loaded wire bail is secured, and a bait mechanism engageable by a holding wire arranged to temporarily hold the bail in a set position, an improvement which comprises life terminating engagement surfaces (LTES) positioned on the base to establish a killing force on an animal in combination with the wire bail when the animal is struck by the sprung wire bail.

16. The animal trap of claim 15, wherein said LTES is a fixable upright flange.

17. The animal trap of claim 16, wherein said fixable upright flange is at about a 90 degree angle from the base of the trap.

18. The animal trap of claim 15, wherein said LTES is a molded upright flange.

19. The animal trap of claim 18, wherein said molded upright flange is between about a 65 and about a 115 degree angle from the base of the trap.

20. The animal trap of claim 15, wherein said molded upright flange extends upwardly at about 90 degrees from the base of the trap.

21. The animal trap of claim 16, wherein the upright flange is between about 0.25 inch and about 0.75 inch in height from the base.

22. The animal trap of claim 15, wherein the LTES is positioned around the bait mechanism.

23. The animal trap of claim 22, wherein said LTES shape follows the shape of said bail and is positioned slightly to the interior of said sprung bail.

24. The animal trap of claim 22, wherein said LTES shape follows the shape of said bail and is positioned slightly to the exterior of said sprung bail.

25. The animal trap of claim 15, wherein said LTES is formed on a sleeve securable to said base.

26. A method of killing an animal comprising of the steps:
a. affixing life terminating engagement surfaces (LTES) on a conventional snap-trap having a baiting mechanism, a wire bail, a holding wire, and a catch mechanism;
b. applying bait to the trap baiting mechanism;
c. cocking the wire bail of the trap to a set position;
d. placing the holding wire of the trap over the wire bail;
e. securing the holding wire with the catch mechanism;
f. mechanically striking the animal with the wire bail after the animal dislodges the catch mechanism from the holding wire; and
g. mechanically engaging the animal on the LTES for a rapid killing of the animal.
